(19) United States
(12) Patent Application Publication
(10) Pub. No.: US 2014/0181180 A1
(43) Pub. Date: Jun. 26, 2014

(54) Multi-Websites contents fetcher software system

(71) Applicants: Jing Wu, Barrington, IL (US); Jesse Wu, Barrington, IL (US)

(72) Inventors: Jing Wu, Barrington, IL (US); Jesse Wu, Barrington, IL (US)

(21) Appl. No.: 13/725,620

(22) Filed: Dec. 21, 2012

(51) Int. Cl. H04L 29/08

(52) U.S. Cl. CPC H04L 67/02
USPC 709/203

(57) ABSTRACT

This invention includes uniquely designed implementation methods and processes that enable multi-website content to be displayed at the end user's or server-defined selection. To achieve this purpose, the multi-website content-fetching system implements content-selection methods and apparatus to create desired web page access aside from using URLs (uniform resource locator). This system can also aggregate multiple web pages to a local data structure on physical media, change contents, references and modify links in the data structure systems in order to display multi-website content correctly, the way users would see the content using traditional browsers. Also implemented is a server-directed process to access web content that further improves efficiency for multi-websites content fetching and display efforts. Finally, the multi-website content fetcher utilizes one-mouse-click operations to aggregate and correctly display user-selected or server-defined web content. This is a small entity application.

### CROSS-REFERENCE TO RELATED U.S. PATENT APPLICATION

This application claims priority under 35 U.S.C. section. 119 to U.S. Provisional Patent Application Ser. No. US 61/582,831 entitled “Multi-Websites contents fetcher software system” by Jing Wu and Jesse Wu, which was filed on Jan. 4, 2012, the entirety of which is hereby incorporated by reference.

### TECHNICAL FIELD

This invention relates to multi-website content retrieval, modification, and display.

### BACKGROUND OF THE INVENTION

Traditional methods of accessing websites are based on web browsers. However, through a web browser, users are only able to access websites one at a time. The drawbacks of the traditional method force users to use repetitive typing and mouse movements to find the desired web content, and when users have multiple pages of results spread between different browser sessions, the results can not be viewed together. In certain cases, users will save time if results for multiple searching criteria on different websites are aggregated.

### BRIEF SUMMARY OF THE INVENTION

This invention addresses the problems mentioned above. The one-mouse-click solution provided by the multi-website content fetcher provides a faster, more efficient way of getting results together in an organized fashion after accessing or searching multiple websites. This is accomplished by the system methods described herein. The system is capable of taking demands, from either the end user or a server, regarding which websites to search, how content should be modified or filtered, and how these contents can be recorded for access later on.

The content-selection methods used to achieve the above objectives depend on unique system notation to retrieve content from more than one webpage. This notation is one format by which the system can receive inputs about the target URL and search criteria. Furthermore, the system's multi-website aggregation method stores different web content into local PC or tablet physical data structures, either file(s) or data structures on storage media, and converts the web contents into a browser-viewable format. These functionalities of the system are made simple and clear for users through the one-mouse-click method for retrieving contents from multiple websites.

### CROSS-REFERENCE TO RELATED APPLICATIONS

Not applicable.

### STATEMENT REGARDING FEDERALLY SPONSORED RESEARCH OR DEVELOPMENT

Not applicable.

### DETAILED DESCRIPTION OF THE INVENTION

A URL (uniform resource locator) is unique for each web page. To access a website or web page, the normal method is to use URL to specify a website or web page. However, when more than one web pages or websites are accessed, it is not normally possible to specify multiple websites/webpages or their accessing methods. To view pages from different websites/webpages, the multi-website content fetcher system's solution is to develop the extension methods for URLs when specifying the pages. These extension methods comprise notations using { } [ ] ( ) to specify what contents are to be searched and how many pages of results should be aggregated in the search, as well as how content should be accessed and displayed to the end user.

The invention's use of { } [ ] ( ) notations themselves comprises methods to regenerate URLs that allow users to get content from multiple web pages while visiting one website. This URL regeneration method scans the URL syntax for patterns in changes and then modifies and replaces portions of the URL to create new URLs. This URL regeneration method can be directed by the end user's specifications through the use of { } [ ] ( ) notations. As an example, if a user named Mr. Sam W. Johnson is searching for webpages of results for one URL on the www.yourfavoriteurl.com, assume that the URL contains information on the page being displayed, such as“. . . page=”. For Mr. Johnson to use { } [ ] ( ) notation in getting results from www.yourfavoriteurl.com, he could input yourfavoriteurl{page=(200:1)} into the system's interface. This notation would tell the system to recreate URLs from page number 0 to 200, with interval of 1. After running the system, Mr. Johnson would have two-hundred pages of web content at his disposal. The system will fetch all content from those 200 web pages designated by the entered URL and its related 200 pages. As another example, using the same method notation within { } [ ] ( ), Mr. Johnson can specify the login process and password for the system to access websites using the parameters specified within { } [ ] ( ) characters. In addition, Mr. Johnson can specify the HTTP accessing methods to use (POST or GET.), what keywords to search and which website to fetch results from, whether the results should be displayed in detail or just as indices to the page, the save location, and what URLs he wishes to include in or exclude from his searches based off of his URL patterns. All information provided to the search system by the user can be expressed in the { } [ ] ( ) notation that is claimed, among other methods, in claim 1.

Continuing off of Mr. Johnson's use of the system, once Mr. Johnson has finished receiving all the contents (web pages from one or more websites) from the internet, the system is able to store them in the data structures of local media, i.e. a file, files, or data structures on storage media. Built into the system's saving methods is the process by which the data structure's contents are resolved and repaired to correct all non-displayable contents and references that arise from differences on web pages and websites. These differences may be language related, relative references and indices to the locations of the contents, HTML or XHTML structures related, or webpage-design related. All instances of non-displayable and cross-influence content must be removed by the system for the end user to see multi-web page content from one site or more sites correctly. The system thus aggregates multiple web pages from multiple websites, records their contents to data structure(s), and modifies and repairs their contents before displaying the content correctly.

The system's design allows both local user-driven and server-directed access in the input of these notations for the multi-website fetching system (a browsing system). In the case of Mr. Johnson, the system was operated in a user-driven fashion. With the alternative server-directed accessing method, the multi-website fetching system first downloads all the server-defined notations from the websites. These notations instruct the browser on where to find web content, methods to regenerate new URLs and methods to access the websites, and methods to modify and filter content. After receiving and loading this information, the system might prompt users for information on search criteria if needed by the server. This information could include keywords, locations, or type of commodities, personal information to narrow down the search. After entering server-specified criteria into the user interface and select websites from the server provided web access list, the multi-content fetcher system proceeds to fetch web content and display the final, modified or filtered contents to the end user in the similar way as locally inputted notations.

This system is designed to remedy the one- or multi-website searching issues or display inefficiency issues as explained above. The system is intended to relieve users of certain repetitive motions normally needed when accessing the websites they visit daily.

The one-mouse-click solution and related methods claimed within this document reduce operational burdens and improve efficiency.

1) The methods for uniform resource locator (URL) extension that use { } [ ] ( ) operators, including website content selection and URL regeneration notation and related methods; the notation and methods that use website-accessing Post, Get, other HTTP operations, and user login processes and data manipulations; user-driven selection of web page content that is to be collected and displayed; the system-specific syntax designed for this system that searches for String patterns in URLs and then selects and regenerates new URLs; the content-selection methods with { } [ ] ( ) notation representation designed to access different pages across multiple URLs.

2) The methods for aggregating multi-website contents into physical data structures on physical storage media: this includes use of a single file, multiple files, or data structures in other storage media; the methods for modification of references and contents in the data structures on the physical media in order to show selected multi-website content correctly; the process for manipulating and modifying web-content references across multiple websites; the methods for modifying web content to be displayed to the user in the way traditional browsers would display the content.

3) The methods for server-directed multi-website access as an alternative to purely user-driven multi-website access, including the gathering of user-specified search criteria, the correct handling user selections from server-specified web access lists, server-specified URL regeneration, server-specified URL access, server-specified content modification and filters.
